(19) United States
(12) Patent Application Publication
(10) Pub. No.: US 2005/0279563 A1
(43) Pub. Date: Dec. 22, 2005

(54) Steerable bogie

(76) Inventor: Robin A. Peterson, Port Orange, FL (US)

Correspondence Address: LAW OFFICES OF BRIAN S STEINBERGER, 101 BREVARD AVENUE, COCOA, FL, 32922, US

(21) Appl. No.: 10/869,006

(22) Filed: Jun. 16, 2004

(51) Int. Cl. B62D 5/06

(52) U.S. Cl. 180/414

(57) ABSTRACT

Steering assemblies, methods and systems for powered or engine driven tandem axles used with work vehicles. A heavy duty work vehicle for rough terrain includes a tandem axle wherein engine power is transferred equally to both the front and rear ground following wheels of the tandem axle thru knuckle spindle steerable ends. A fluid system such as a hydraulic system unilaterally can control all four wheels or ground engagement tire positions of a single dual beam tandem or bogie assembly.

### FIELD OF INVENTION

This invention relates to steerable mechanisms, in particular to steerable tandem front axle systems and bogie axles and methods for providing maneuverability, greater stability, greater safety and unilateral controllability to the load bearing end of six wheel work vehicles used for construction sites, mill yards and rough terrain/obstacle sites.

### BACKGROUND AND PRIOR ART

Four wheel construction work vehicles such as telescopic rough terrain fork trucks and forestry yard trucks with single axle load end are known for being very versatile and maneuverable but have difficulties in areas such as ground tire penetration (floatation), stability, maneuverability and safety. Since the load end of such vehicles has only a single steerable axle with just two tires, current vehicles lack the attributes of four tires on the load end and are not as safe and stable as could be.

Work vehicles must be able to continuously maneuver around various obstacles during their operation. The lack of stability in current maneuverable four wheel vehicles causes the operator to compensate by driving greater distances at possibly faster speeds and steering the vehicles a great deal too constantly maneuver about a work site at what should be slow speeds because of the loads being carried. Such extra driving takes more time, fuel and adds the danger of unstable loads moving about construction sites, adding overall costs and hazards to the work operation.

Using a single front (load end) pair of steerable wheels has inherent safety issues. These types of work vehicles have been known to have tires sink into the ground, tip over and injure both workers and the vehicle equipment during use. Such safety issues cause undesirable delays and extra costs to work projects.

Current work vehicles primary have four wheels and when loaded they inherently have wheels with high undesirable ground pressure. The loaded four wheel vehicles are known to be less stable, have less steering maneuverability and are not as safe as they should be. This has been addressed by current practices of the addition of hydraulic out riggers (legs) on the load end that can be deployed when the vehicle is not in motion. However, this practice defeats the vehicles purpose (motion) and is only utilized at the most urgent times, which raises questionable safety issues.

Various patents have been proposed over the years. For example, the inventor is aware of U.S. Pat. No. 1,145,893 to Hewett; U.S. Pat. No. 1,845,318 to Mooers; U.S. Pat. No. 2,492,126 to Collender; U.S. Pat. No. 2,642,144 to Brewer, Jr.; U.S. Pat. No. 3,083,782 to Ivaldi; U.S. Pat. No. 3,295,623 to Kyzer; U.S. Pat. No. 3,799,362 to Oswald et al.; U.S. Pat. No. 3,810,516 to Reimer; U.S. Pat. No. 3,930,669 to Kollander et al.; U.S. Pat. No. 3,977,693 to Gamaunt; U.S. Pat. No. 4,048,925 to Storm; U.S. Pat. No. 4,120,509 to Reeve et al.; U.S. Pat. No. 4,128,137 to Booth; U.S. Pat. No. 4,153,265 to McColl; U.S. Pat. No. 4,205,730 to McColl; U.S. Pat. No. 4,207,956 to McColl; U.S. Pat. No. 4,213,719 to Swisher, Jr. et al.; U.S. Pat. No. 4,296,826 to Van Der Lely; U.S. Pat. No. 4,350,190 to McColl; U.S. Pat. No. 4,462,477 to Mastro; U.S. Pat. No. 4,519,468 to Mick; U.S. Pat. No. 4,572,311 to Oswald et al.; U.S. Pat. No. 4,632,194 to Averill et al.; U.S. Pat. No. 4,941,539 to Kopczynski; U.S. Pat. No. 4,969,530 to Kopczynski; U.S. Pat. No. 5,242,131 to Watts; U.S. Pat. No. 5,308,216 to Herolf; U.S. Pat. No. 5,417,297 to Auer; U.S. Pat. No. 5,429,056 to Pees et al.; U.S. Pat. No. 5,595,359 to Meneghetti; U.S. Pat. No. 5,732,789 to Stephenson; U.S. Pat. No. 5,904,365 to Dillon; U.S. Pat. No. 6,053,837 to Auer; U.S. Pat. No. 6,102,415 to Stewardson; U.S. Pat. No. 6,247,196 to Jurmu; U.S. Pat. No. 6,450,524 to Lippens et al.; U.S. Pat. No. 6,454,294 to Bittner et al.; U.S. Patent Application Publication 2003/0230213A1 to Schaller et al.; and U.S. Patent Application Publication 2003/0168825 A1 to Henderson.

However, none of these patents overcomes all the problems with the prior art described above.

Thus, the need exists for solutions to the above problems with the prior art.

### SUMMARY OF THE INVENTION

A primary objective of the present invention is to provide steerable front load end axle assemblies, systems and methods for six wheel work vehicles used on construction sites, mill yards, and rough terrain/obstacle sites that achieve greater travelablity, maneuverability and versatility than current steering four wheel mechanisms on work vehicles.

A secondary objective of the present invention is provide steerable front (load end) axle assemblies, systems and methods for six wheel work vehicles used for construction sites mill yards and rough terrain obstacle sites that achieves greater stability and safety than current four wheel steering mechanisms on work vehicles.

A third objective of the present invention is to provide steerable front (load end) axle assemblies, systems and methods for six wheel work vehicles used for construction sites, mill yards and rough terrain/obstacle sites that is faster and less costly to operate than current four wheel steering mechanisms on work vehicles.

A fourth objective of the present invention is to provide steerable front (load end) axle assemblies, systems, and methods on work vehicles which reduces ground pressure over the current two wheels and is more stable and no less maneuverable when carrying work loads over the vehicles equipped with a single steerable axle with two wheels under the load end.

The invention can include a steerable mechanism consisting of steerable knuckle spindle assemblies, tandem beams, linkages, cylinders and hydraulic/electric controls for tandem axle/bogies of and for work vehicles particularly those having maneuvering requirements in difficult construction sites mill yards or rough terrain/obstacle sites.

The work vehicles with which the invention finds use, and utility are specifically but not limited to fork trucks, telescopic rough terrain fork trucks and mill yards where loads carried by the vehicles over the tandem end will be less disturbed during the traveling motion of the vehicle. This is inherent to the tandem/bogies ability to transfer only half of the wheel and or tire vertical movements into the tandem beam or vehicle frame mounting connection. Specific to the configuration of most rough terrain telescopic fork trucks is the required steering ability on each end of the vehicle. This has been addressed by the use of a single steerable axle at each end. This invention will allow the advantageous use of a powered steerable tandem beam/bogie under the load carrying end of such vehicles.

Various types of tandem beam axles, with either gear or roller chains drive mechanisms, with full structural support beam mounting and full gear train enclosures with planetary drives is well known and in use as current present day technology. The tandem beam/bogie axle main attributes of ground pressure reduction, stability, traction, safety and increased load capacity without steering ability could not be applied to close quarter maneuvering vehicles. This invention addresses tandem beam/bogie application for load carrying vehicles that travel in areas, construction and others, where maneuvering is of concern or necessity.

Work vehicles utilizing the novel invention of steerable powered tandem beam/bogie axles can make use of those attributes of reduction of load motions during travel, ability to travel around or over ground laden obstacles with minimum affects to the load, ability to travel at higher speeds, reduction of ground pressure, reduction of ground damage, four wheel/tire ground contact under the vehicle lifting end for greater stability and improved safety of all operational modes.

Further objects and advantages of this invention will be apparent from the following detailed description of the presently preferred embodiments which are illustrated schematically in the accompanying drawings.

### BRIEF DESCRIPTION OF THE FIGURES

FIG. 1 is a perspective view of a four wheel steerable axle assembly of the invention shown without wheels.

FIG. 2 is a top view of the steerable axle assembly of FIG. 1 shown with wheel sections.

FIG. 3 is another top view of the steerable assembly of the preceding figures with wheels steered to the right.

FIG. 4 is another top view of the steerable assembly of the preceding figures with wheels steered to the left.

FIG. 5 is a top enlarged partial cross-sectional view of half of the steerable assembly.

FIG. 6 is a cross-sectional view of the knuckle portion of FIG. 5 along arrows 6X.

FIG. 7 is a schematic view of the hydraulic system for use with the steerable assembly.

FIG. 8 is another schematic of the hydraulic system of FIG. 7 with computer control.

FIG. 9 is an enlarged side view of the tandem beam portion of the preceding figures with rear wheels raised upward while passing over raised surface.

FIG. 10 is an enlarged side view of the tandem beam portion of the preceding figures with front wheel raised upward while passing over a raised surface.

FIG. 11 is a side view of a work vehicle fork truck using the novel steerable assembly.

FIG. 12 is a top view of the work vehicle of FIG. 11.

### DESCRIPTION OF THE PREFERRED EMBODIMENTS

Before explaining the disclosed embodiments of the present invention in detail it is to be understood that the invention is not limited in its applications to the details of the particular arrangements shown since the invention is capable of other embodiments. Also, the terminology used herein is for the purpose of description and not of limitation.

The components in the figures will now be identified.
1 Steerable axle assembly.
10 Tandem Beam(s)
20 Steerable Knuckle Spindle
30 Bearing Attachment
50 Differential
60 Vehicle Frame Mounting Points
70 Wheels
80 Kingpin Mounting
90 Steering Control Torque Arm
100 Gears
110 Universal Joints
120 Wheel Mounting or Planetary Gear reduction Wheel Mounting
130 Link
139 Hydraulic System
139′ Hydraulic System with Computer Control
140 Hydraulic Cylinder
150 Cylinder Rod
160 Hydraulic pump
170 Hydraulic steering valve
180 Cylinder piston
190, 191, 192, 193 Cylinder ports
220 Electronic knuckle spindle position sensor
230 Electrical/hydraulic manifold assembly
240 Computer Control
250 Ground Engagement Point
260 Drive Line
270 Shafts and Gears
280 Brakes
400 Fork Truck

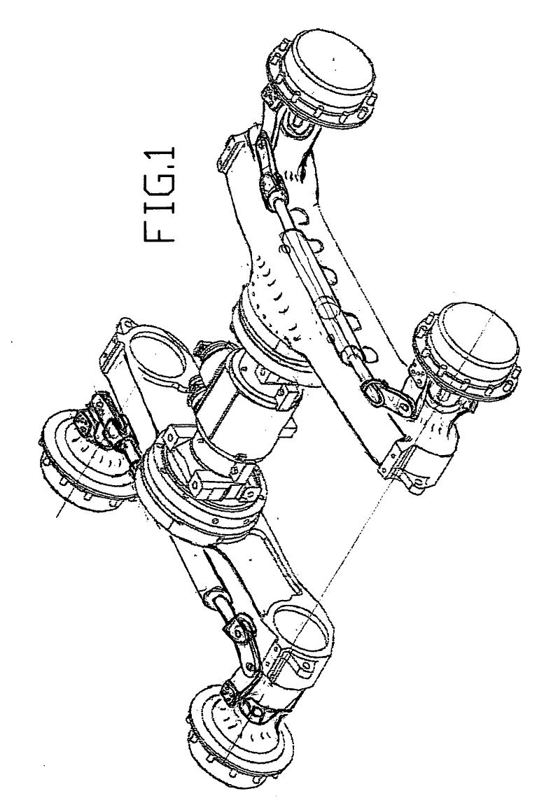

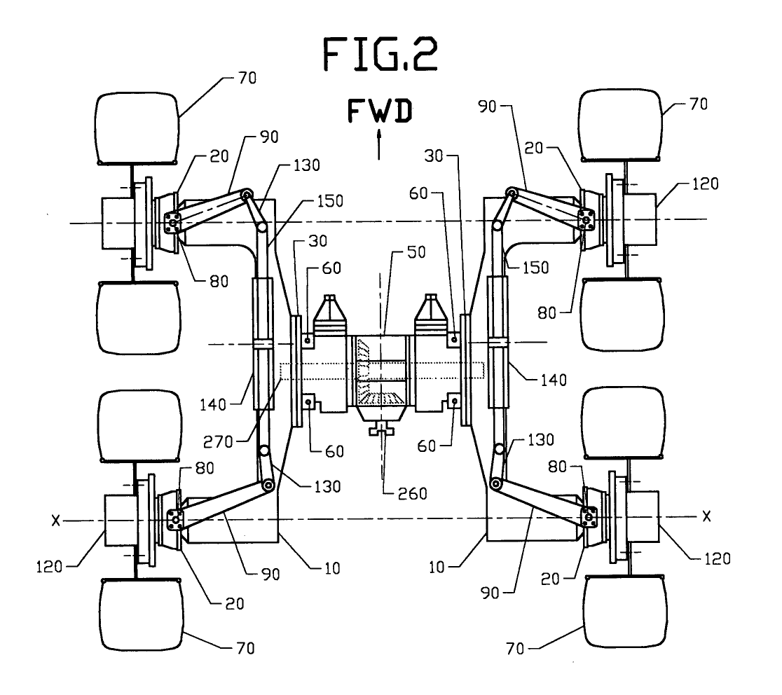

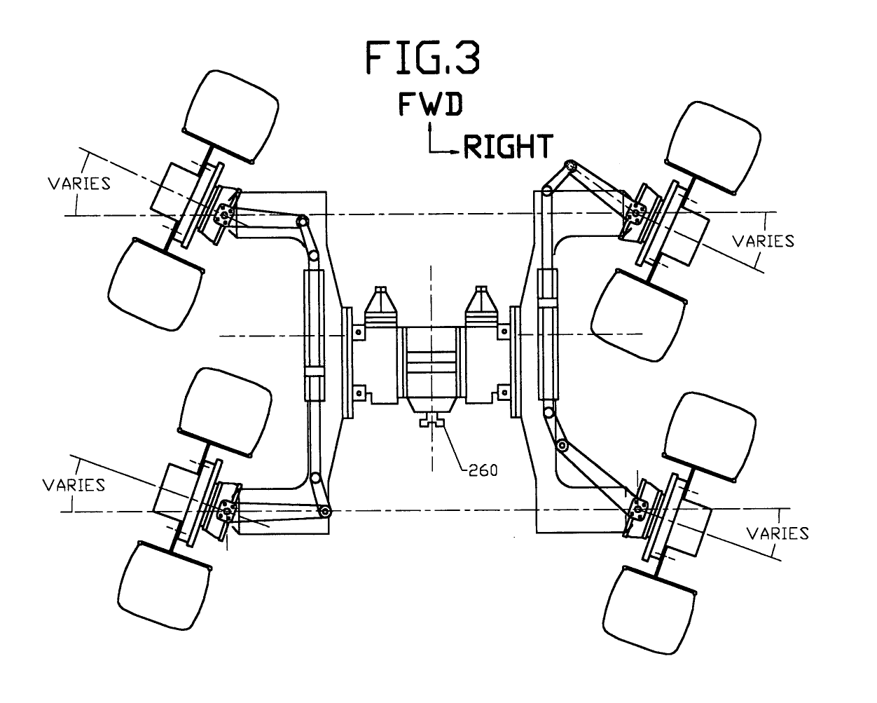

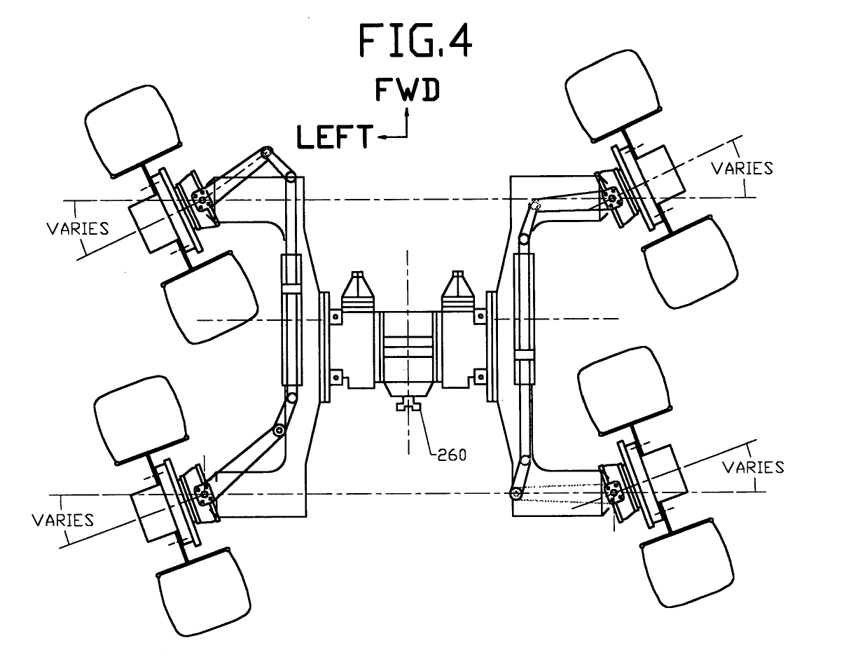

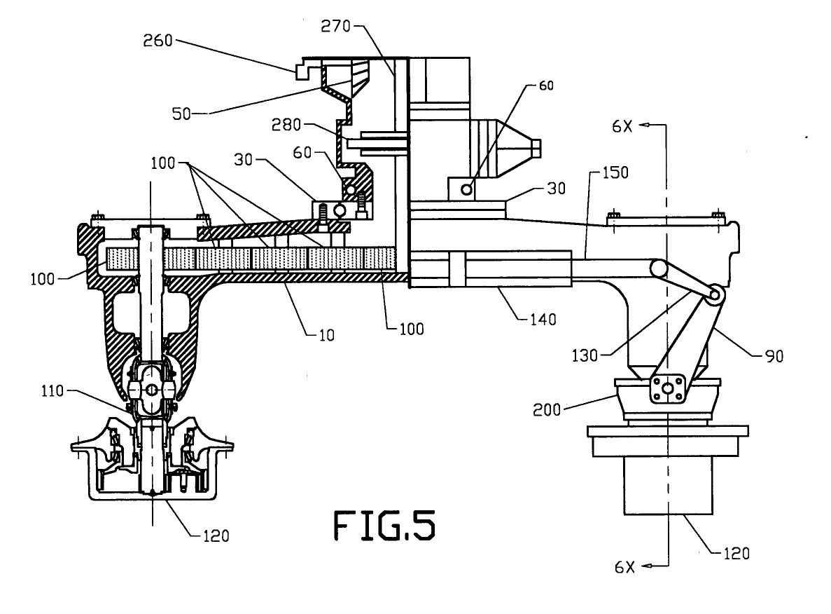

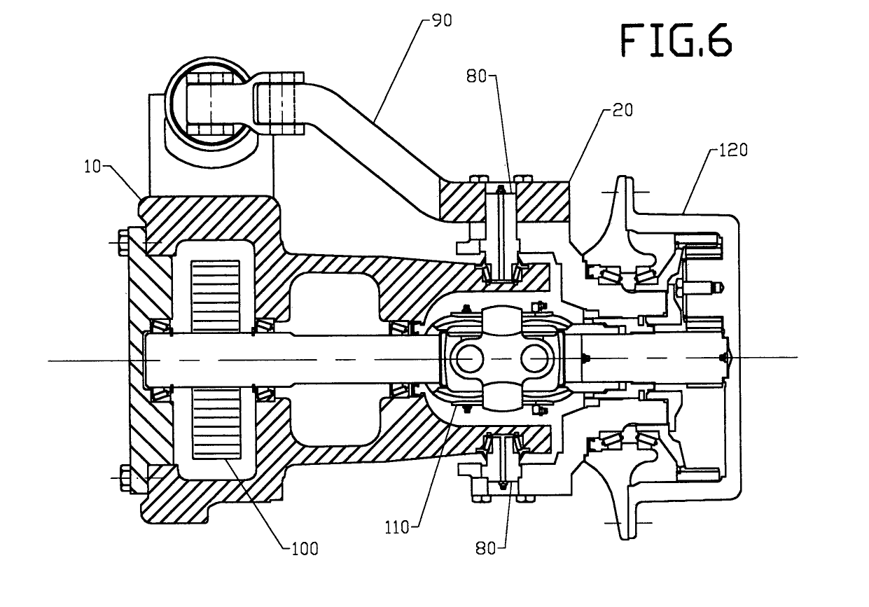

Referring to FIGS. 1-6, the invention can include a practical, integrated steering assembly 1 for powered tandem axles, each having a tandem beam 10, having rear and front wheels 70, attached to steerable knuckle spindle 20. Each tandem beam 10, assembly can have a left side and right side that mirrors each other yet independent for steering control from differential 50, vehicle frame mounting points 60, and the up and down or swing motion of each tandem beam 10.

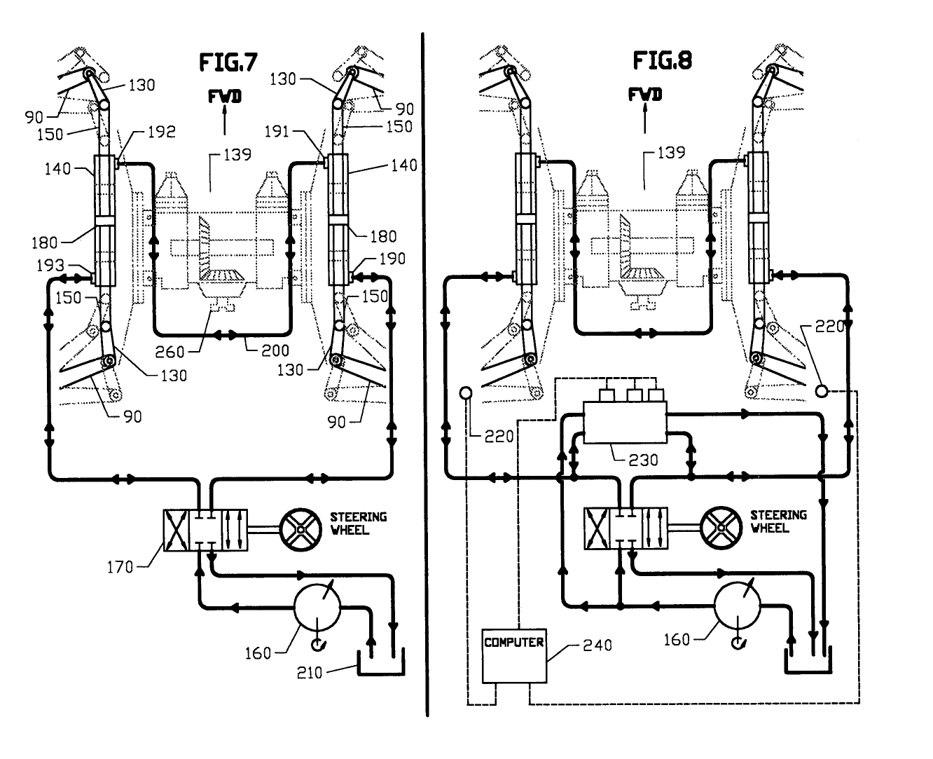

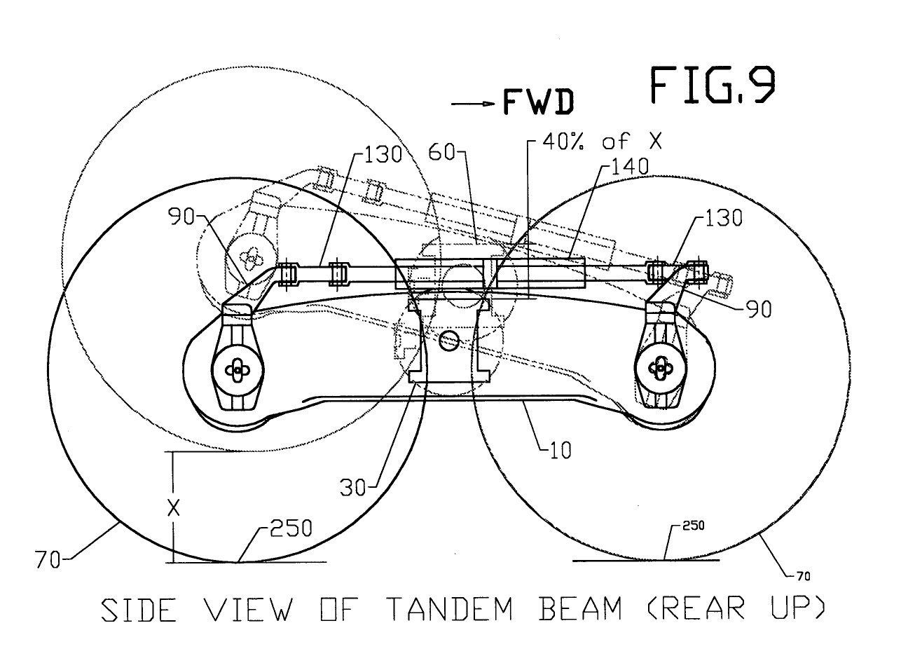

FIG. 7 is a schematic view of the hydraulic system 139 for use with the steerable assembly 1 of the preceding figures. FIG. 8 is another schematic of the hydraulic system 139′ of FIG. 7 with computer control 240.

FIG. 9 is an enlarged side view of the tandem beam portion 10 of the preceding figures with rear wheels raised upward while passing over raised surface and illustrating the vehicle frame mounting points moving less than one half (½) in actuality approximately 40% the wheel motion.

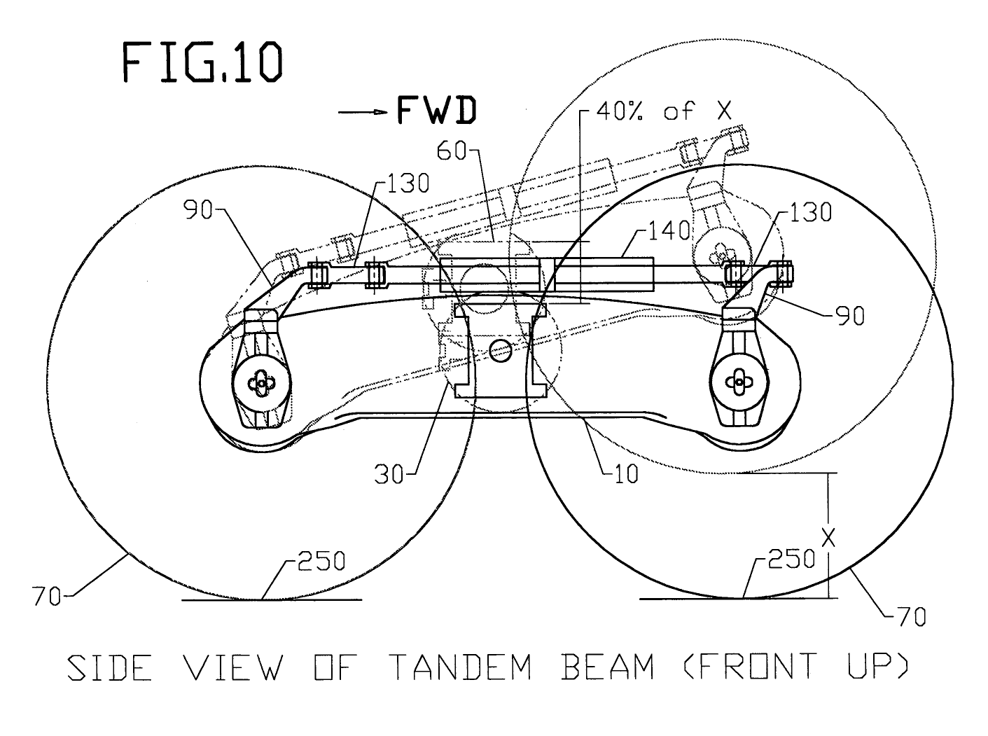

FIG. 10 is an enlarged side view of the tandem beam portion 10 of the preceding figures with front wheel raised upward while passing over a raised surface illustrating the vehicle frame mounting points moving less then approximately 40% of the wheel motion.

For clarity illustrations FIG. 9 and FIG. 10 are shown in the up vertical wheel motion however the same example can exist for down vertical wheel motion if the wheel (tire) drops into a depression or sinks the resulting frame motion will be 40% of the wheel or tire movement.

Referring to FIGS. 1-10, on the forward and rear end's of each tandem beam 10, can be mounted a steerable knuckle spindle 20, assembly that will travel, up and down, or rotate about a central pivot point of bearing attachment 30, as each tandem beams 10, (wheel) tires 70, follow the ground contour at (wheel) tire each ground engagement point 250.

Each steerable knuckle spindle assembly 20, can have an attached steering control torque arm 90, that follows both the up and down swing motion of the tandem beam 10, and the rotation motion of each Knuckle spindle 20, about the kingpin mounting 80. The length of each of the steering control torque arms 90, varies with the angle geometries required for the differences of front and rear wheel 70, turning radius requirements. A link 130, is mounted to the end of each steering control torque arm 90, and the opposite end of each link can be connected to the hydraulic cylinder 140, that is integrated or hard mounted directly to each tandem beam 10. That cylinder 140, follows all motion related to tandem beam 10, movements. The link 130, provides the transfer of forces (push pull motion) generated by the hydraulic cylinder 140, push-pull motion to the steering swing of each steerable knuckle spindle assembly 20. The hydraulic cylinder 140, that is integrated or hard mounted to each tandem beam 10, can be of a through rod configuration (expressly the cylinder rod 150, extends from both ends of the cylinder 140) and provides as a relay for solid, physical, mechanical control of the steering knuckle spindle assemblies 20, that are located on the front and rear of each tandem beam 1. The hydraulic displacement of the steering cylinders 140, is identical left tandem beam 10, to right tandem beam 10. The hydraulic displacement is identical at both ends of a common cylinder 140.

Power from drive line 260, and differential 50, can be transferred via shafts and gears 270 past brakes 280, through the tandem bearing mounting 30, into the enclosed tandem 10, where power is transferred to the front and rear of each tandem beam 10, via gears 100, or roller chains to the attached steerable knuckle spindle 20, where power is transferred by industry standard flexible drive coupling systems like universal joints 110, to the wheel mounting or planetary gear reduction wheel mounting 120.

As shown in FIGS. 7 and 8, the hydraulic cylinder steering control schematic can include at least two embodiments. The first FIG. 7 can be a simple type embodiment consisting of a hydraulic pump 160, either manual or powered by an engine or electric motor with a hydraulic control valve 170, that will send hydraulic oil, pressure and flow, to either end of the right or left tandem steer cylinders 140. The hydraulic oil, pressure and flow, will force the piston 180, thus moving the cylinder rod 150, away from the steering cylinder hydraulic oil inlet port 190.

The hydraulic oil forced from the opposite end of that steer cylinder 140, will exit that same cylinder port 191, where the hydraulic oil will be routed through hoses and or tubing 200, to inlet port 192, of the second tandem steering cylinder 140. This will force the piston 180, and rod assembly 150, in the second tandem steer cylinder 140, away from the hydraulic oil inlet port 192, forcing hydraulic oil out the opposite port 193, of the same second tandem steer cylinder 140 back to the oil reservoir 210.

The second hydraulic control system embodiment in FIG. 8 works identical to the first with respect to hydraulic oil flow. The exception and differences exist with the addition of electronic steering knuckle spindle or cylinder position sensors 220, and an electro/hydraulic valve 230, and or manifold assemblies that can add hydraulic oil or remove hydraulic oil from the left-right tandem beam steer cylinder 140, hydraulic hose/tube circuit connection loop 200. A programmable logic controller 240, (computer) can be used to sense the difference of steering knuckle spindle 20, position from the operational base line requirements of optimal wheel and tire 70, tracking and automatically correct. This system can also capable of full electronic steering if needed.

In both embodiments of FIGS. 7 and 8, the tandem beam mounted hydraulic cylinder 140, and the push pull piston 180, and rod 150, movement along with each tandems 10, steering link 110, connected to the steering control torque arms 90, the swinging action mounted to the knuckle spindles 20, will be unaffected by the radial up and down (wheel lift for fall) motion of each independent ground following tandem beam 10. Hydraulic schematics FIG. 7 and FIG. 8 are illustrated in the simplest form for clarity for one skilled in the art.

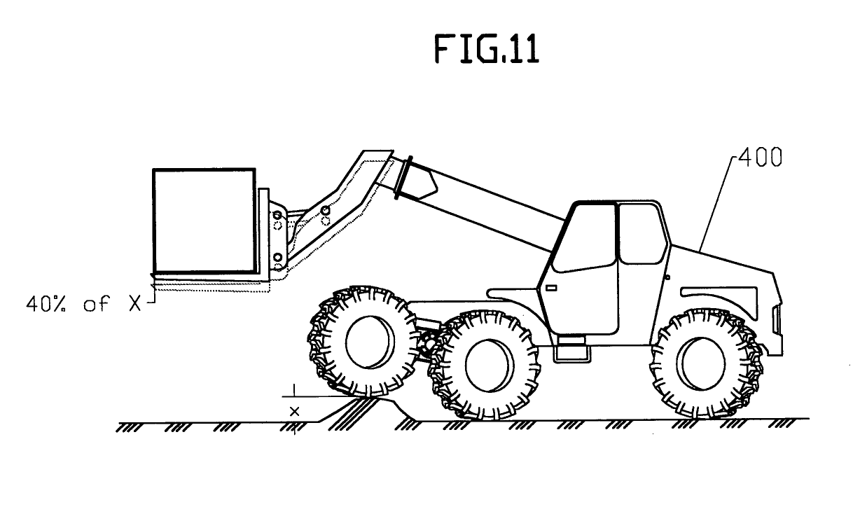

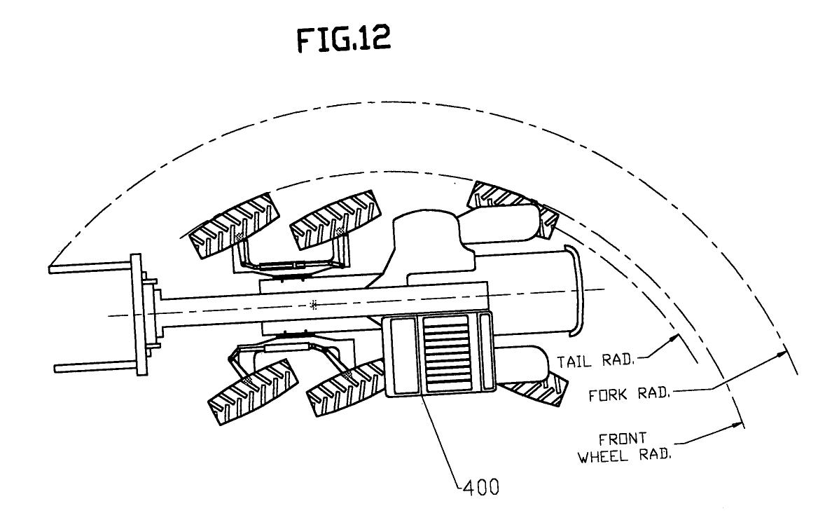

FIG. 11 is a side view of a work vehicle fork truck 400 using the novel steerable assembly 1. FIG. 12 is a top view of the work vehicle 400 of FIG. 11.

The steerable front load end axle assemblies, systems and methods of the invention can be used on six wheel work vehicles that are used on construction sites, mill yards, and rough terrain/obstacle sites. The novel steerable front load end axle assemblies, and systems allow for greater travelablity, maneuverability and versatility than current steering four wheel mechanisms on work vehicles.

Further, the steerable front (load end) axle assemblies, systems and methods of the invention achieve greater stability and safety than current four wheel steering mechanisms on work vehicles.

Additionally, the steerable front (load end) axle assemblies, systems and methods for six wheel work vehicles used for construction sites, mill yards and rough terrain/obstacle sites of the invention would be faster and less costly to operate than current four wheel steering mechanisms on work vehicles.

Still furthermore, the steerable front (load end) axle assemblies, systems, and methods used on work vehicles of the subject invention reduces ground pressure over the current two wheels and would be more stable and no less maneuverable when carrying work loads over the vehicles equipped with a single steerable axle with two wheels under the load end.

Although work vehicles such as fork trucks are described, the invention has application to other work vehicle applications such as but not limited to elevated work platforms such as cherry pickers, fire trucks, cranes, power lifting vehicles, commercial as well as military vehicles, and the like, as well as other moveable tools requiring stability while in transit.

The low ground pressure benefits of the invention allows for using work vehicles on various surfaces such as but not limited to forrest surfaces, beach terrain, dessert terrain such as having soft sand, mud, as well as on any other type of ground surface.

The invention can be used on either or both the front or rear ends of vehicles. Work vehicles using the invention can have six or eight wheels.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

1. A tandem axle steering assembly for work vehicles, comprising:
a main shaft having a first end and a second end;
a first tandem beam attached to and perpendicular the first end of the shaft;
a first pair of wheels attached the first tandem beam;
a first steer mechanism for uniformly steering the first pair of wheels a second tandem beam attached to and perpendicular to the second end of the shaft;
a second pair of wheels attached to the second tandem beam;
a second steer mechanism for uniformly steering the second pair of wheels; and
a controller for simultaneously controlling both the first steer mechanism and the second steer mechanism so that both the first pair of wheels and the second pair of wheels are maintained in a continuous steering orientation to each other while being steered by the controller, wherein the assembly is useful for a work vehicle.

2. The tandem axle steering assembly of claim 1, wherein each of the first tandem beam and the second tandem beam further comprise:
a central pivotal portion for allowing each wheel in the first and second pair of wheels to move up and down relative to one another while following uneven ground contour surfaces.

3. The tandem axle steering assembly of claim 1, wherein the controller includes:
a hydraulic system for controlling each of the first steer mechanism and the second steer mechanism.

4. The tandem axle steering assembly of claim 3, wherein the first steer mechanism and the second steer mechanism each include hydraulic cylinders.

5. The tandem axle steering assembly of claim 1, wherein the work vehicle includes:
a fork truck having a load positioned over the tandem axle steering assembly.

6. The tandem axle steering assembly of claim 5, wherein the fork truck further includes:
a rear steerable axle having wheels located behind the tandem axle steering assembly, the rear steerable axle being steerable by an operator thru the controller so that the wheels on the rear steerable axle are continuously steered together with the first and the second pair of wheels on the tandem axle steering assembly.

7. The tandem axle steering assembly of claim 5, wherein the load in the fork truck is raised or falls less in height while wheels on the tandem axle steering assembly are being raised while passing over a rise or depression on the ground surface.

8. A method of tandem axle steering for work vehicles, comprising the steps of:
providing a main shaft having a first end and a second end, a first tandem beam attached to and perpendicular the first end of the shaft with a first pair of wheels attached the first tandem beam, a second tandem beam attached to and perpendicular to the second end of the shaft with a second pair of wheels attached to the second tandem beam;
uniformly steering the first pair of wheels with the first steer mechanism;
uniformly steering the second pair of wheels with a second steer mechanism; and
simultaneously controlling both the first steer mechanism and the second steer mechanism with a controller so that both the first pair of wheels and the second pair of wheels are maintained in a continuous steering orientation to each other while being steered by the controller, wherein the assembly is useful for a work vehicle.

9. The method of claim 8, wherein each of the first tandem beam and the second tandem beam further comprise the step of:
allowing each wheel in the first and second pair of wheels to move up and down relative to one another while following uneven ground contour surfaces by a central pivotal portion.

10. The method of claim 8, further comprising the step of:
providing a hydraulic system as the controller for controlling each of the first steer mechanism and the second steer mechanism.

11. The method of claim 10, further comprising the step of:
providing hydraulic cylinders for each of the first steer mechanism and the second steer mechanism.

12. The method of claim 8, further comprising the step of:
providing a fork truck as the work vehicle having a load positioned over the tandem axle steering assembly.

13. The method of claim 12, further comprising the step of:
providing a rear steerable axle having wheels located behind the tandem axle steering assembly; and
steering the rear steerable axle by an operator thru the controller so that the wheels on the rear steerable axle are continuously steered together with the first and the second pair of wheels on the tandem axle steering assembly.

14. The method of claim 12, further comprising the step of:
raising or lowering the load in the fork less in height while the wheels on the tandem axle steering assembly are being raised while passing over a rise or depression on the ground surface.

15. A system for tandem axle steering on work vehicles, comprising:
a main shaft having a first end and a second end;
a first tandem beam attached to and perpendicular the first end of the shaft with a first pair of wheels attached the first tandem beam;
a first steer component for uniformly steering the first pair of wheels a second tandem beam attached to and perpendicular to the second end of the shaft with a second pair of wheels attached to the second tandem beam;
a second steer component for uniformly steering the second pair of wheels; and
a controller for simultaneously controlling both the first steer and the second steer components so that both the first pair of wheels and the second pair of wheels are maintained in a continuous steering orientation to each other while being steered by the controller, wherein the system is useful on work vehicles.
